(19) United States
(12) Patent Application Publication
(10) Pub. No.: US 2003/0024160 A1
(43) Pub. Date: Feb. 6, 2003

(54) Hanging plant basket liner system

(76) Inventor: Ronald W. Hendrickson, Rock Lake, ND (US)

Correspondence Address: Michael S. Neustel, Suite No. 4, 2534 South University Drive, Fargo, ND, 58103, US

(21) Appl. No.: 09/921,723

(22) Filed: Aug. 3, 2001

(51) Int. Cl. A47G 7/02; A01G 9/02

(52) U.S. Cl. 47/67

(57) ABSTRACT

A hanging plant basket liner system for improving water retention thereby requiring less frequent watering. The hanging plant basket liner system includes a liner member comprised of a flax straw material positioned within a support frame for receiving a plant and potting soil. The liner member is preferably formed into a concave shape. The liner member is comprised of a volume of flax straw and a volume of poly fiber. The poly fiber is melted within the flax straw thereby connecting the flax straw together.

### BACKGROUND OF THE INVENTION

1. Field of the Invention

The present invention relates generally to plant basket liners and more specifically it relates to a hanging plant basket liner system for improving water retention thereby requiring less frequent watering.

2. Description of the Prior Art

Plant basket liners have been in use for years. Typically, conventional plant basket liners are comprised of either coir (i.e. coconut fiber) or sphagnum moss. However, conventional plant basket liners require frequent watering to maintain a healthy plant. Individuals that are busy require another person to monitor their plants to ensure that they are receiving the proper water amount.

While these devices may be suitable for the particular purpose to which they address, they are not as suitable for improving water retention thereby requiring less frequent watering. Conventional plant basket liners require frequent watering which is undesirable for active individuals today.

In these respects, the hanging plant basket liner system according to the present invention substantially departs from the conventional concepts and designs of the prior art, and in so doing provides an apparatus primarily developed for the purpose of improving water retention thereby requiring less frequent watering.

### SUMMARY OF THE INVENTION

In view of the foregoing disadvantages inherent in the known types of plant basket liners now present in the prior art, the present invention provides a new hanging plant basket liner system construction wherein the same can be utilized for improving water retention thereby requiring less frequent watering.

The general purpose of the present invention, which will be described subsequently in greater detail, is to provide a new hanging plant basket liner system that has many of the advantages of the plant basket liners mentioned heretofore and many novel features that result in a new hanging plant basket liner system which is not anticipated, rendered obvious, suggested, or even implied by any of the prior art plant basket liners, either alone or in any combination thereof.

To attain this, the present invention generally comprises a liner member comprised of a flax straw material positioned within a support frame for receiving a plant and potting soil. The liner member is comprised of a volume of flax straw and a volume of poly fiber. The poly fiber is melted within the flax straw thereby connecting the flax straw together.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a hanging plant basket liner system that will overcome the shortcomings of the prior art devices.

A second object is to provide a hanging plant basket liner system for improving water retention thereby requiring less frequent watering.

Another object is to provide a hanging plant basket liner system that may be utilized with various types and sizes of plants.

An additional object is to provide a hanging plant basket liner system that promotes healthy plant growth.

A further object is to provide a hanging plant basket liner system that does not require an individual to monitor their plants for watering everyday.

Another object is to provide a hanging plant basket liner system that makes it easier for individuals to own and manage plants within their home or business.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the liner member within a support frame supporting a plant.

FIG. 2 is an exploded view illustrating the liner member between the potting soil and the support frame.

FIG. 3 is a top view of the liner member disclosing the interior corrugated cavity.

FIG. 4 is a cross sectional view taken along line 4-4 of FIG. 3.

FIG. 5 is a side view of the liner member.

### DESCRIPTION OF THE PREFERRED EMBODIMENT

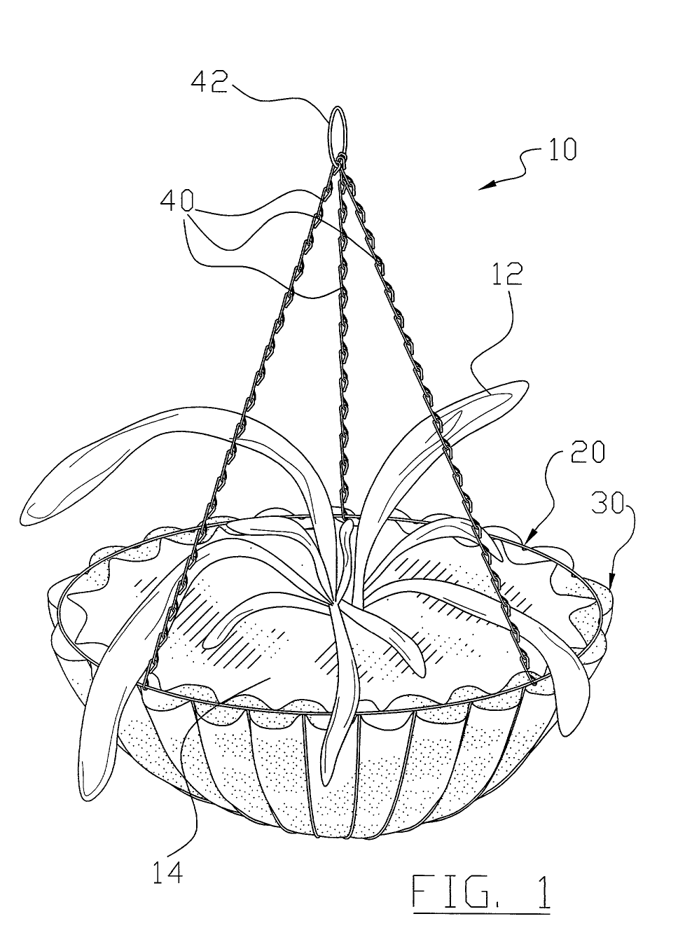

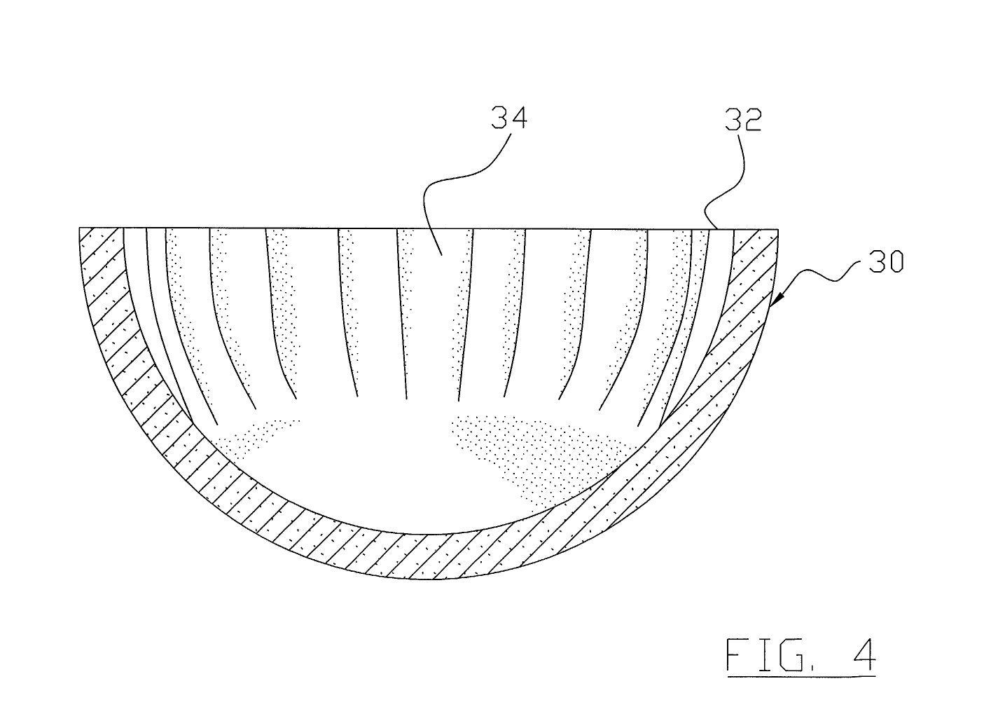

Turning now descriptively to the drawings, in which similar reference characters denote similar elements throughout the several views, FIGS. 1 through 5 illustrate a hanging plant basket liner system 10, which comprises a liner member 30 comprised of a flax straw material positioned within a support frame 20 for receiving a plant 12 and potting soil 14. The liner member 30 is comprised of a volume of flax straw and a volume of poly fiber. The flax straw is comprised of a volume of flax fiber and flax stem depending upon the physical characteristics desired. The poly fiber is melted within the flax straw thereby connecting the flax straw together.

Flax straw is a byproduct of the harvesting of flax and other conventional processes. The FLAX COUNCIL OF CANADA provides an informative web site regarding the various usages of flax (www.flaxcouncil.ca). There are various varieties of flax as is well-known in the art, any of which are suitable for usage within the present invention.

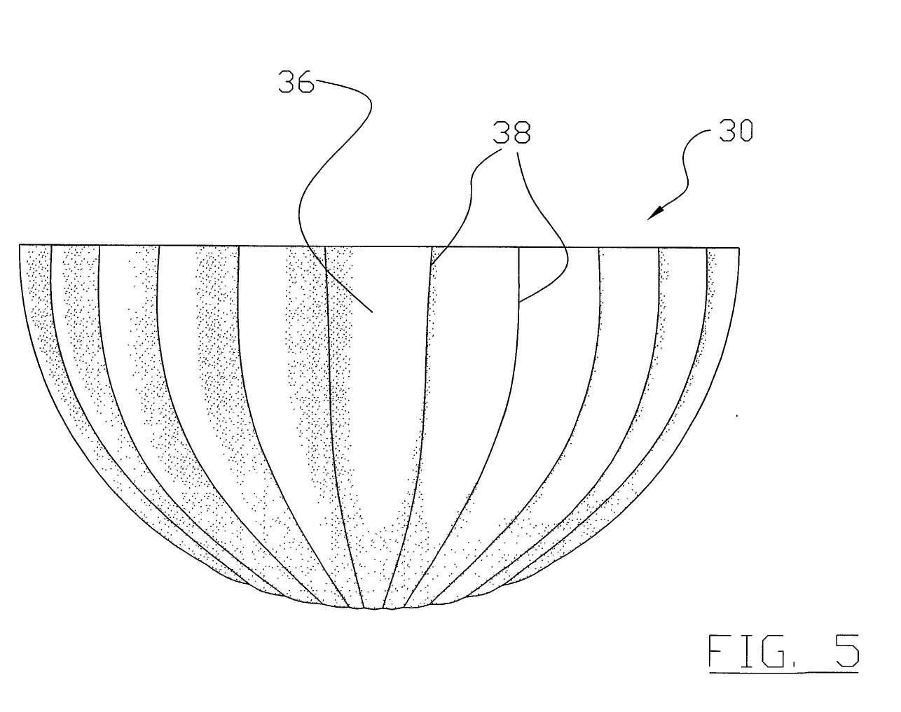

As shown in FIG. 5 of the drawings, the first step in manufacturing the present invention is to provide a volume of flax straw in a bale or similar structure. The flax straw may be provided through direct cutting or through conventional combining with a straw chopper then baling which further facilitates the separation of the flax fiber from the flax stem. Baling of flax straw creates a higher concentration of fiber within the bale as the stem portions often times settle to the ground while baling up the straw with the more concentrated fiber content. The bale is then broken apart by flailing or hammer milling to separate the flax straw into a loose accumulation which further separates the stems and the fiber into a more concentrated fiber of suitable length. The flailing or hammer milling of the flax straw also breaks the coarse flax fibers into a plurality of finer flax fibers depending upon the overall usage desired.

One suitable system for sorting the flax straw is utilized within the hay grinding industry wherein tub grinders allow only specific lengths of straw to pass through. The length of the flax fibers is preferably limited to less than 3½ inches in length, however greater lengths of straw fibers may also be utilized. The control of the overall fiber length is important for the proper flow of material through the nonwoven textile process utilized later in the manufacturing process. The flax straw initially is comprised of between 70-80 percent flax stem and 20-30 percent flax fiber. The sorted flax straw is typically comprised of 20-50 percent flax stem with the remaining flax straw mixture comprised of flax fiber. Various other mixture combinations of the flax fiber and flax stems may be achieved utilizing conventional sorting processes.

The sorted flax straw is then combined with a volume of poly fibers. Poly fibers are commonly utilized with one manufacturer of such fiber material being KOSA (www.kosa.com) such as Type 255 CELBOND biocomponent fiber. The poly fibers are thoroughly mixed within the flax straw to ensure consistent coverage within the flax straw.

The volume of poly fibers utilizes is preferably between 4 to 6 percent by volume, however volumes greater than 6 percent and less than 4 percent may be utilized. If the user desires to increase the absorption of the mat member, then they will utilize less poly fibers with the flax straw. If the user desires to increase the strength and weed prevention of the mat member, then they will utilize more poly fibers with the flax straw.

After the poly fibers are combined with the flax straw, the user then positions the flax straw and poly fiber mixture into a webbing machine that creates a “blanket” or other physical structure by blowing the mixture of flax straw and poly fiber onto a platform or a mold at a desired thickness. The thickness of the blanket of material may vary from lesser or greater than ⅛ of an inch. An acceptable machine for performing the air-laid nonwoven textile process is a RANDO WEBBING MACHINE utilizing an air-laid manufacturing process to create the blanket. Various other types and brands of machinery may be utilized to perform the air-laid nonwoven textile process upon the flax straw and poly fiber.

Various other types and brands of machinery may be utilized to perform the nonwoven textile process upon the flax straw and poly fiber. In addition, various other mechanical procedures may be performed upon the blanket such as mechanically entangling the fibers in a vertical manner with either barbed needles, water jets or combination thereof.

After the mixture of flax straw and poly fibers have been laid into a blanket structure, the blanket structure is then processed through a heated oven for melting the poly fibers within the flax straw as shown in FIG. 5 of the drawings. The melted poly fibers bond with adjacent flax straw thereby connecting the flax straw together into a stable structure either as a blanket or formed into various shapes. The blanket is then removed from the heated oven with the melted poly fibers cooling and solidifying thereby retaining the flax straw within a desired physical structure. The blanket may be cut into various shapes for baskets as can be appreciated by one skilled in the art.

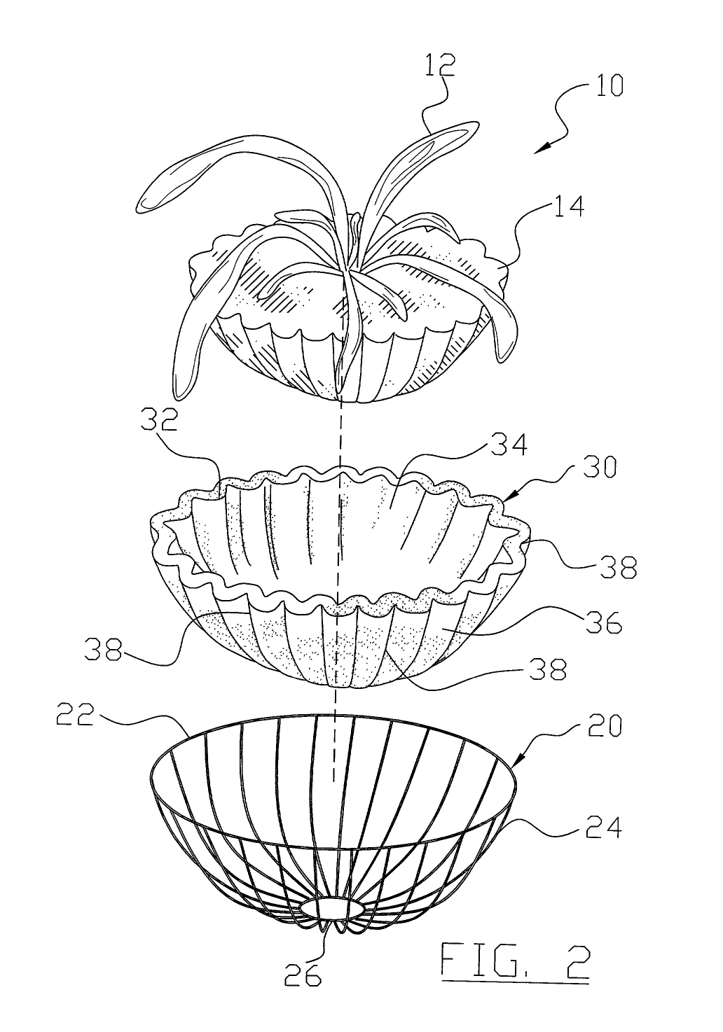

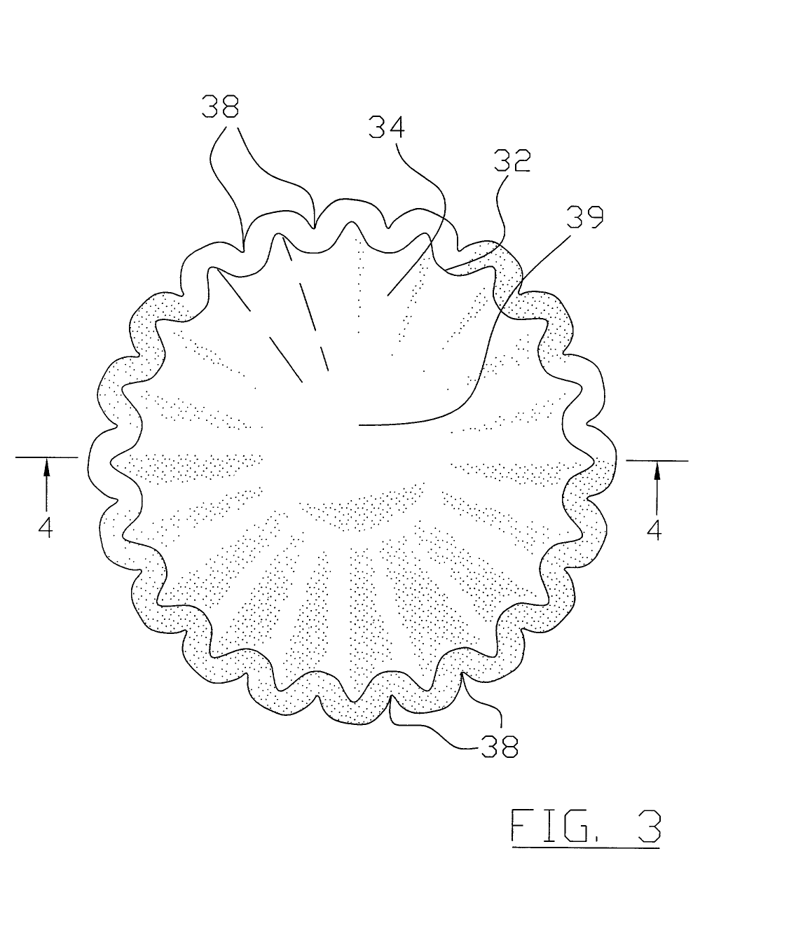

After the mixture of flax straw and poly fibers have been air-laid into a blanket structure, the blanket structure can be positioned within a mold formed to a shape similar to the support frame 20 and then processed through a heated oven for melting the poly fibers within the flax straw. The melted poly fibers bond with adjacent flax straw thereby connecting the flax straw together into a stable liner member 30. The liner member 30 is preferably concave shaped as shown in FIGS. 2 and 3 of the drawings, however variations may be made to this structure. The liner member 30 is then removed from the heated oven with the melted poly fibers cooling and solidifying thereby retaining the flax straw within a desired physical structure as shown in FIGS. 2 through 5 of the drawings.

As shown FIGS. 2 through 5 of the drawings, the liner member 30 is comprised of an inner surface 34, an outer surface 36, an upper opening 32, and a floor 39. The upper opening 32 is formed for receiving the potting soil 14 and the plant 12 as shown in FIGS. 1 and 2 of the drawings. The liner member 30 further includes a plurality of longitudinal indentions 38 extending inwardly from the outer surface 36 as best illustrated in FIGS. 1, 3 and 5 of the drawings. The indentions 38 are formed for snugly fitting about the rib members 24 of the support frame 20 as illustrated in FIG. 1 of the drawings.

As shown in FIGS. 1 and 2 of the drawings, the support frame 20 is preferably constructed of an upper rim 22, a lower ring 26, and a plurality of rib members 24 extending between the upper rim 22 and the lower ring 26. The support frame 20 is formed into a structure similar to the outer surface 36 of the liner member 30 as shown in FIG. 2 of the drawings. The support frame 20 may be comprised of various types of materials such as but not limited to wire. As shown in FIG. 1 of the drawings, a plurality of support lines are attached to the support frame 20 and extend upwardly to a common loop member for securing and supporting the support frame 20 during usage.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A hanging plant basket liner, comprising:
a liner member having a concave shape, wherein said liner member has an inner surface, an outer surface; and
wherein said liner member is comprised of a volume of flax straw and a volume of poly fiber mixed within said volume of flax straw, wherein said volume of poly fiber has been melted to bond with said volume of flax straw.

2. The hanging plant basket liner of claim 1, wherein said hanging plant basket liner includes a plurality of indentions extending into said outer surface for corresponding to a plurality of rib members of a support frame.

3. The hanging plant basket liner of claim 1, wherein said volume of poly fiber is at least 1 percent by weight or volume.

4. The hanging plant basket liner of claim 1, wherein said volume of poly fiber is less than 7 percent by volume.

5. The hanging plant basket liner of claim 1, wherein said volume of poly fiber is less than 7 percent by weight.

6. The hanging plant basket liner of claim 1, wherein said horticultural mat is comprised of a rectangular shape.

7. The hanging plant basket liner system of claim 1, wherein said liner member is comprised of a circular shape.

8. The hanging plant basket liner system of claim 1, wherein said volume of flax straw is comprised of a volume of flax fiber of at least 50%.

9. A method of manufacturing a hanging plant basket liner, comprising the steps of:
(a) providing a volume of flax straw;
(b) combining a volume of poly fiber with said volume of flax straw forming a straw fiber mixture;
(c) applying an air-laid nonwoven textile process to said straw fiber mixture forming a blanket;
(d) positioning said blanket within a mold having a concave shaped inner cavity thereby forming said blanket into a concave shape;
(e) applying heat to said mold and said blanket thereby melting said volume of poly fiber within said straw fiber mixture forming a liner member having a concave shape; and
(f) cooling said liner member thereby bonding said volume of poly fiber and said volume of straw.

10. The method of manufacturing a hanging plant basket liner of claim 9, wherein said hanging plant basket liner includes a plurality of indentions extending into said outer surface for corresponding to a plurality of rib members of a support frame.

11. The method of manufacturing a hanging plant basket liner of claim 9, wherein said volume of poly fiber is at least 1 percent by weight or volume.

12. The method of manufacturing a hanging plant basket liner of claim 9, wherein said volume of poly fiber is less than 7 percent by volume.

13. The method of manufacturing a hanging plant basket liner of claim 9, wherein said volume of poly fiber is less than 7 percent by weight.

14. The method of manufacturing a hanging plant basket liner system of claim 9, wherein said volume of flax straw is comprised of a volume of flax fiber of at least 50%.

15. A method of manufacturing a hanging plant basket liner, comprising the steps of:
(a) providing a volume of flax straw;
(b) sorting said flax straw according to a maximum length of each piece of flax straw;
(c) combining a volume of poly fiber with said volume of flax straw forming a straw fiber mixture;
(d) applying an air-laid nonwoven textile process to said straw fiber mixture forming a blanket;
(e) positioning said blanket within a mold having a concave shaped inner cavity thereby forming said blanket into a concave shape;
(f) applying heat to said mold and said blanket thereby melting said volume of poly fiber within said straw fiber mixture forming a liner member having a concave shape; and
(g) cooling said liner member thereby bonding said volume of poly fiber and said volume of straw.

16. The method of manufacturing a hanging plant basket liner of claim 15, wherein said maximum length is 3½ inches.

17. The method of manufacturing a hanging plant basket liner of claim 15, wherein said hanging plant basket liner includes a plurality of indentions extending into said outer surface for corresponding to a plurality of rib members of a support frame.

18. The method of manufacturing a hanging plant basket liner of claim 15, wherein said volume of poly fiber is at least 1 percent by weight or volume.

19. The method of manufacturing a hanging plant basket liner of claim 15, wherein said volume of poly fiber is less than 7 percent by volume.

20. The method of manufacturing a hanging plant basket liner system of claim 15, wherein said volume of flax straw is comprised of a volume of flax fiber of at least 50%.
